(19) United States
(12) Patent Application Publication
(10) Pub. No.: US 2016/0276083 A1
(43) Pub. Date: Sep. 22, 2016

(54) CYLINDRICAL SUPERCONDUCTING MAGNET

(71) Applicant: SIEMENS PLC, Camberley (GB)

(72) Inventor: Graham HUTTON, Oxfordshire (GB)

(73) Assignee: SIEMENS PLC, Camberley (GB)

(21) Appl. No.: 14/442,267

(22) PCT Filed: Nov. 11, 2013
(86) PCT No.: PCT/EP2013/073500

§ 371 Date: May 12, 2015

(30) Foreign Application Priority Data
Nov. 12, 2012 (GB) 1220325.3

(51) Int. Cl. H01F 6/06; H01F 6/02

(52) U.S. Cl. CPC H01F 6/065; H01F 6/02

(57) ABSTRACT

A cylindrical superconducting magnet structure (24) comprising two superconducting main coils (10) respectively axially spaced apart by a spacer coil (16), said main coils and said spacer coil being bonded together in a single self-supporting structure.

### BACKGROUND OF THE INVENTION

1. Field of the Invention

The present invention relates to cylindrical superconducting magnet structures, particularly such structures in which a number of separate superconducting coils are provided, linked by spacers, but which are formed into a single self-supporting structure. Examples of such structures are described in International patent application WO2011/148163.

2. Description of the Prior Art

FIG. 1A illustrates a conventional monolithic cylindrical coil structure 110 of the general type described above. A-A represents an axial mid-plane, and Z-Z represents an axial direction. Four coils 10 are provided and are retained in defined relative positions by spacers 14. In the illustrated example, discrete spacers 14 are placed at circumferential intervals around the circumference of the coils, as illustrated, and each spacer 14 is bonded at its axial extremities to axial extremities of two adjacent coils 10. The spacers 14 may be formed of a filler material, such as glass fibre, impregnated with an epoxy resin, while the coils 10 are typically coils of superconducting wire, largely of copper matrix material, impregnated with a similar or the same epoxy resin.

FIG. 1B illustrates a distribution of current density in a known coil structure similar to that described above and illustrated in FIG. 1A. A-A represents an axial mid-plane, and Z-Z represents an axial direction. Dimension J represents the current density at each axial point. Coils 10 are represented by positive current density. In this case, all coils have equal current density J. The coils 10 are represented, spaced apart by gaps 12 of zero current density. The gaps are typically defined by spacers 14, represented in FIG. 1A, which hold the coils in their fixed relative positions. The spacers do not carry a current, and so give rise to the gaps 12 of zero current density.

The intermittent nature of the spacers 14 around the circumference of the coils means that axial forces are unevenly distributed around the circumference of the coil. Replacing the intermittent spacers 14 with a continuous annular spacer may provide a more even distribution of axial forces around the circumference of the coils. However, when the superconducting coils 10 are cooled to an operating temperature, the differences in thermal contraction between the material of the coils and the material of the spacers may lead to significant stress between the coils and the spacers. Similarly, during a quench of the magnet, the superconducting coils revert to their resistive state, and a significant amount of energy is dissipated by heating in the coils. This leads to rapid thermal expansion of the material of the coils, and again causes significant thermal stress between the coils and the spacers. The stresses between coils and spacers caused by differential thermal contraction and expansion may be greater than stresses caused by interaction of electromagnetic fields, in use.

CN101533078 describes a conventional coil arrangement.

### SUMMARY OF THE INVENTION

The present invention provides a cylindrical superconducting magnet structure in which annular spacers are provided, yet the problems of differential thermal expansion and contraction are reduced or eliminated. The present invention removes or reduces the thermal mismatch between materials used for the coils and the spacers, and so avoids or reduced generation of thermal stress at interfaces between coils and spacers.

Certain embodiments of the present invention also provide effective quench propagation. If one part of one coil quenches, the resultant heating rapidly causes the adjacent coils to quench, spreading the dissipation of stored energy and ensuring that no single part of the coil assembly becomes so hot that it is damaged.

The present invention is particularly relevant to low-field, low-cost superconducting magnets, but may find application to cylindrical superconducting magnets of any size.

The present invention accordingly provides superconducting magnet structures as recited in the appended claims.

### BRIEF DESCRIPTION OF THE DRAWINGS

FIG. 1A shows a known superconducting magnet structure.

FIG. 1B shows current density in a known superconducting magnet structure as shown in FIG. 1A.

FIG. 2A shows a superconducting magnet structure according to an embodiment of the present invention.

FIG. 2B shows current density in a superconducting magnet structure according to an embodiment of the present invention as shown in FIG. 2A.

FIGS. 3A-3D explain an exemplary design of a cylindrical superconducting magnet according to an embodiment of the present invention.

FIGS. 4A-4C illustrate an exemplary method for manufacturing coils useful in the present invention.

FIG. 5 illustrates an axial cross-section of a portion of an embodiment of the invention.

FIG. 6 illustrates insulating spacers which may optionally be employed in embodiments of the present invention.

### DESCRIPTION OF THE PREFERRED EMBODIMENTS

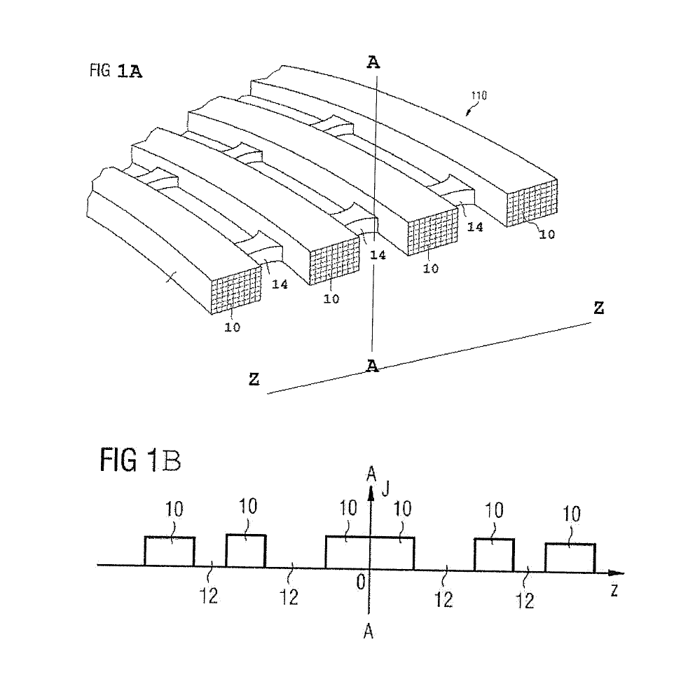

According to the present invention, the discrete, circumferentially-spaced spacers 14 of known coil structures of FIG. 1A described above are replaced by turns of wire, typically impregnated with resin, and having very similar thermal properties to those of the magnet coils 10. These turns of wire make up coils which are bonded axially between superconducting coils of the magnet structure. For ease of reference in the following description, these turns of wire will be referred to as “spacer coils”, and the magnet coils 10 will be referred to as “main coils”.

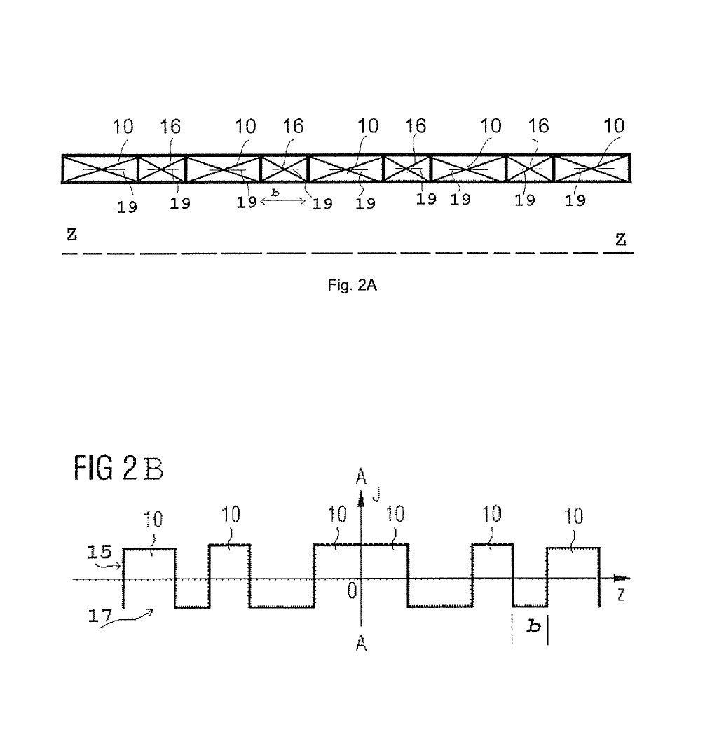

FIG. 2A illustrates an axial half-cross-section of a monolithic superconducting magnet structure according to an embodiment of the present invention. Five main coils 10 are represented. Between the main coils 10 are spacer coils 16. The illustration in FIG. 2A is schematic only. Spacer coils 16 would be expected to have a smaller axial dimension b than the main coils 10.

Preferably, the spacer coils 16 have inner radii at least substantially equal to those of the adjacent main coils 10. More preferably, the spacer coils 16 have both inner and outer radii at least substantially equal to those of the adjacent forward coils 10. In such a structure, any compressive or expansive tension between forward coils 10 and spacer coils 16 is spread over the axial surfaces of the coils. In some embodiments, a spacer coil 16 may have inner and/or outer radii equal to the corresponding dimension of the adjacent magnet coils 10. In situations where magnet coils 10 have different inner and/or outer radii, the corresponding dimension of the intervening spacer coil may be intermediate between the corresponding dimension of the adjacent main coils. Even in cases where inner and outer radii of spacer coils and main coils are not substantially equal, each coil should be present at a radial location corresponding to the radial mid-point 19 of the or each abutting coil, to avoid significant bending moments on the structure when under axial load.

The spacer coils 16 may be electrically unconnected, or may be arranged to carry an electric current in the opposite direction to the current carried by the magnet coils (“reverse current”), to carry a current in the same direction as the current carried by the magnet coils (“forward current”), or may be connected to other circuitry such as a quench propagation circuit. According to their intended connection, the spacer coils may be of superconducting wire or resistive wire. In embodiments where the spacer coils are resistive, they may be connected to a quench propagation circuit such that, in case of a quench in one main coil, current is diverted into the resistive spacer coils which heat and so spread the quench to other main coils.

FIG. 2B illustrates a distribution of current density in a monolithic superconducting magnet structure according to an embodiment of the present invention as represented in FIG. 2A. In this embodiment, the spacer coils 16 are of superconducting wire, and are arranged to carry reverse current—that is, current in the opposite direction to the current carried by the magnet coils 10. The five main coils 10 are represented in FIG. 2B with positive current density. Between the forward coils, spacer coils 16 are represented by negative current density. Preferably, the magnitude of current density is the same for both main coils and spacer coils. However, the polarities are opposite, and the axial extent b of the spacer coils 16 is generally less than the axial extent of the magnet coils 10. The spacer coils 16 may be connected in series with the main coils to carry a reverse current of equal magnitude but opposite polarity.

In embodiments where the spacer coils 16 carry a reverse current, they should be designed with relatively few turns, to avoid degrading the overall magnetic field. As discussed for example in UK patent GB2308451, inclusion of relatively small coils carrying reverse current may enable a shorter overall cylindrical structure to be provided, and still generate a magnetic field of acceptable quality.

This may be particularly important in the design and manufacture of low-cost, low-field cylindrical magnets, since the cryostat which provides the necessary thermal environment for the coils may account for a much greater share of the system cost than the cost of the superconducting wire itself. If the cylindrical magnet can be shortened, then the cryostat may similarly be shortened and its cost reduced by more than the increased wire cost. A shortened cryostat is also beneficial for patient comfort. These advantages are in addition to the benefits in terms of reduced interface stresses between main coils and conventional spacers, as provided by the structure of the invention.

In certain embodiments, the spacer coils may be of superconducting wire, and may be arranged to carry forward current—that is, current in the same direction as the main coils. The current density of the spacer coils may be less than that of the main coils, for example by using superconducting wire of larger cross-section; or connecting the spacer coils independently of the main coils and ramping them with a smaller current; or by co-winding the superconducting wire with a resistive wire or an unconnected superconducting wire.

In embodiments wherein the spacer coils are superconducting, in a quench in any one coil, the resulting heating will rapidly cause quench in neighbouring coils, as soon as they are even slightly heated. The resulting quench propagation along the cylindrical magnet assembly will take place at a much faster rate than in conventional arrangements which rely on detecting a variation in field strength and in response to such variation, activating quench heaters on other coils.

Superconducting spacer coils may alternatively be ramped with a forward or reverse current as required to improve homogeneity of a magnetic field produced by the structure. This may represent a type of shimming.

In some embodiments, ends of resistive spacer coils may be electrically joined together to form inductive loops, electrically unconnected to other coils. In the case of a quench, the falling current in the main coils will induce an opposing current in the resistive spacer coils which will cause heating and quench propagation. In further embodiments, the end of the spacer coils may be unconnected, but still have a similar thermal contraction and expansion to that of the superconducting main coils, and extend around the complete circumference of the main coils, achieving improvements according to the present invention.

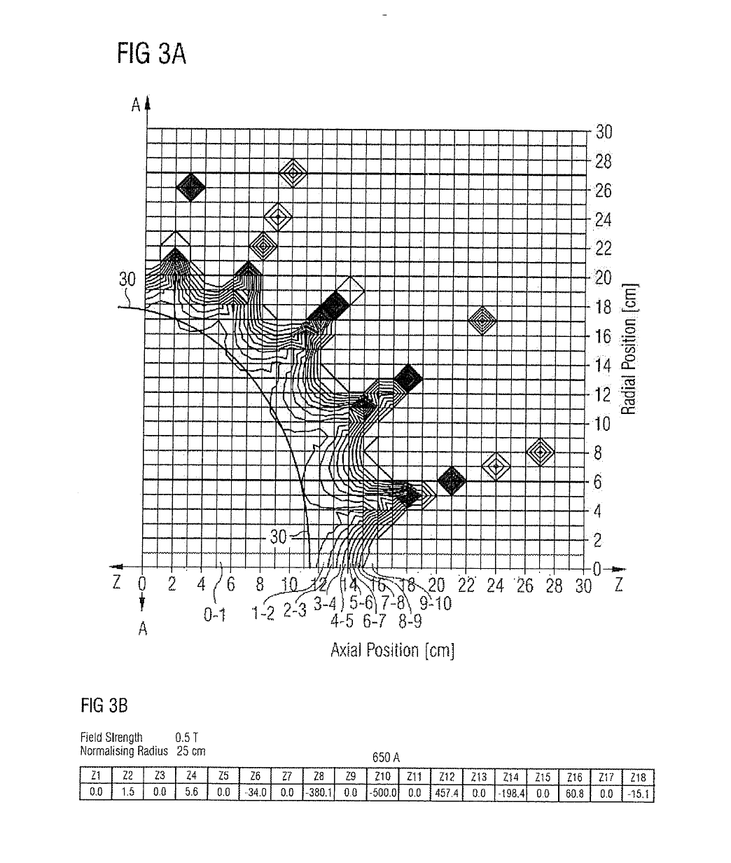

FIGS. 3A-3D show details of an example of a cylindrical superconducting magnet design according to an embodiment of the present invention, in a conventional format which will be familiar to those skilled in the art. This design employs superconducting spacers carrying a reverse current, in which main coils and spacer coils all have the same inner and outer radii. FIG. 3A represents a contour plot of magnetic field homogeneity at the centre of the cylindrical magnet represented by the design. The illustrated field has a nominal strength (flux density) of 0.5 T. FIG. 3A represents a part-cross section through the magnetic field, identified by an axial mid-plane A-A and magnet axis Z-Z. The magnetic field is rotationally symmetrical about axis Z-Z and has reflective symmetry in axial mid-plane A-A so this one-quarter cross-section is sufficient to define the complete magnetic field. The contour values indicated represent inhomogeneity of the magnetic field in units of parts-per-million (ppm). Curve 30 represents the outer limit of a magnetic field region which has a magnetic field inhomogeneity of no more than 1 ppm. In this example, the region of inhomogeneity 1 ppm or less extends about 23 cm axially and about 35 cm radially.

The harmonic analysis of this magnetic field pattern is shown in FIG. 3B for harmonics up to Z¹⁸.

FIG. 3C shows a quarter cross section through the coils 1, 2, 3, 4, 5 of the magnet design, defined by axial mid-plane A-A and a radius R of 40 cm. The coils have reflective symmetry about axial mid-plane A-A and rotational symmetry about axis Z-Z, the origin of radius R.

FIG. 3D includes a tabular description of each of the coils in terms of their inner radius A1, outer radius A2, inner axial limit B1 and outer axial limit B2. The turns density Td is noted for each coil in units of cm⁻², as is the number of turns Trns and the length of superconducting wire used, in metres.

In this example, coils 1, 3, 5 are the main coils and coils 2, 4 are the spacer coils. Corresponding coils are provided in symmetrical orientation the other side of axial mid-plane A-A.

In this example, and preferably, all coils have the same turns-density Trns, and are made from a same size of wire. The total number of reverse turns, shown as a negative value in FIG. 3D, is much less than the total number of forward turns. In the cross-sectional representation of the coils in FIG. 3C, spacer coils carrying a reverse current are indicated with a “−” sign, and main coils are indicated with a “+” sign.

Preferably, all coils are wound in a single winding process and are subjected to a single impregnation step to produce a monolithic structure. In other embodiments, the coils may be formed and impregnated separately in a first impregnation step, and then assembled together in a mould and impregnated a second time with resin, in a second impregnation step, to form the monolithic coils structure, bonded together by the second resin impregnation.

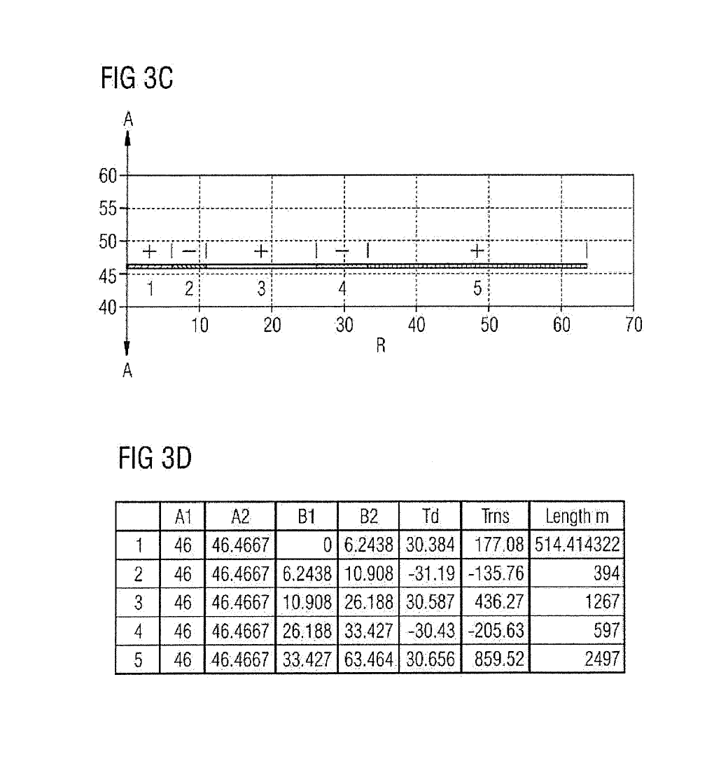

In assemblies according to the present invention, it is necessary to provide arrangements for lead-outs of the ends of the wire for each coil. This may be achieved using a technique similar to that used in the formation of pairs of pancake coils. FIG. 4A shows an example of a pair 100 of pancake coils 102. For ease of understanding, the two pancake coils are shown separated, and wound from tape conductor. In particular, the mid-point 106 of the conductor is at the axially inner extremity of the coil, while the ends 104 of the conductor are at the radially outer extremity of the coil. Conceptually, this may be achieved by a method represented in FIG. 4B. As shown in FIG. 4B, a mandrel 120, which may be a coil journal, part of a coil mould, is provided, and superconducting wire is wound onto the mandrel 120 in opposing directions from two spools 122, 124. More practical arrangements based on this concept will be apparent to those skilled in the art. The wire used to wind such coils need not be a tape such as shown in FIG. 4A, but a more conventional round- or rectangular-section wire.

FIG. 4C schematically illustrates a part-cross-section of a partially-completed coil formed according to such an arrangement. Mandrel 120 is shown having an axial length sufficient to hold several coils 10, 16. Sidecheeks 132, 134, 136 are shown, and are used to define winding cavities. In this example, turns B1-B6 are formed from a first spool 122, while turns A1-A11 are formed from a second spool 124. The starting point 126 for winding the coil is the meeting point of turns A1 and B1, as illustrated in FIG. 4B. As shown in FIG. 4C, one of the spools —122 in this case—may provide only enough turns (B1-B6) to extend from the starting point 126 to the radially outer surface of the coil, to provide access to that end 104 of the wire. The pattern of turns from the respective spools may be changed, for example to restrict voltages between adjacent turns or adjacent layers in case of a quench.

The partially formed coil shown between winding cheeks 134, 136 may be a main coil. Once the coil has been completely wound, sidecheek 134 may be removed, and a spacer coil may be wound into the gap between sidecheek 132 and the main coil shown. The completed main coil may accordingly be used as a sidecheek for winding the adjacent spacer coil. This may be repeated, respectively for main coils and spacer coils, the length of the mandrel 120 until all required coils are wound. In the example where the spacer coils are designed to carry a reverse current, the direction of winding may be changed when beginning to wind the spacer coil, or the spacer coil may be wound in the same direction as the main coils, but electrically connected the other way round. In the case of each coil, the ends 104 of the wire are present at the radially outer surface, making electrical connection of the coils to each other, and to auxiliary circuitry, relatively simple.

In one preferred method of manufacture of a superconducting cylindrical magnet of the present invention, the coils are wound onto a single cylindrical mandrel, for example as described above. An impregnation mould is then assembled around the bobbin and the coils to provide an impregnation cavity. Thermosetting resin is introduced into the cavity, preferably under vacuum. Once the resin is set, the mould and mandrel are removed to leave the self-supporting impregnated coils structure. The mandrel may be provided with a slight taper to aid removal. The effects of such taper must be taken into account at the design stage, when calculating the required number of turns for each coil.

In an alternative method, separately pre-prepared, impregnated coils could be arranged on such a mandrel; the mould could be built and a second resin impregnation performed; the mould and mandrel removed to leave the self-supporting coil structure of the present invention. Such embodiments provide a series of coils with a continuous shared inner radius. In other arrangements, pre-prepared and impregnated coils of differing inner and outer radii may be assembled together by bonding, for example using a thermosetting resin.

The cylindrical superconducting coil arrangements of the present invention are self-supporting and are not provided with a load-bearing former.

The main coils and spacer coils may be electrically joined in series, either by being wound from a single length of wire, in which the direction of winding is reversed for spacer coils as compared to main coils, or by winding each coil as a separate length of wire and electrically joining them in the appropriate direction during assembly of the magnet.

In alternative embodiments of the invention, the spacer coils may be wound with a resistive wire which does not normally carry current, rather than a current-carrying superconducting wire described above. Possible benefits of such an embodiment include the reduced cost of wire for spacer coils, and the opportunity of using the spacer coils to heat the superconducting main coils to spread a quench to protect the main coils in case of the onset of a quench. The spacer coils may be electrically connected to a quench propagation circuit which provides current to the spacer coils in the event of the onset of a quench. Alternatively, the spacer coils may each be a closed loop of resistive wire. In such embodiments, a sudden drop in current in a superconducting main coil caused by a quench may induce an opposing current in the spacer coil, causing heating of the spacer coil which propagates the quench.

Such resistive wire is preferably of a same cross-section as the superconducting wire used for the magnet coils, and constructed of the same material as the matrix material of the superconducting wire, which is typically copper. This ensures that the thermal contraction of such resistive spacer coils is closely matched to the thermal contraction of the magnet coils.

The use of superconducting wire for spacer coils provides advantages, however, in that quench propagation may be improved by having spacer coils which themselves quench and heat in the case of a quench in the main coils, and may enable shortening of the magnet structure as a whole.

In each case, the use of a reverse current-carrying spacer coil in place of a conventional spacer reduces or eliminates the interface stress caused by differing thermal contraction of coils and spacers. As main coils and spacer coils in the present invention are typically formed of the same materials, or substantially the same materials in the case of resistive spacer coils, differential thermal expansion or contraction between main coils and spacers is essentially eliminated.

In the case of superconducting spacer coils, all may be used to contribute to the generation of a homogeneous magnetic field. As will be known by those skilled in the art, and as is made possible by conventional computer-implemented design tools, the introduction of reverse current-carrying coils aids in the generation of regions of homogeneous magnetic field while allowing a reduced overall magnet length.

The present invention is believed to be particularly suitable for relatively low field strength, relatively low-cost devices, where the cost of the required cryostat is more significant than the cost of wire used. The shortened cryostat enabled by the present invention will be reduced in cost, which will offset the cost of the additional superconducting wire used.

While the present invention may be applied to cylindrical superconducting magnets having an arbitrary number of main coils and spacer coils, the minimum requirement for a cylindrical magnet according to the present invention is two superconducting main coils 10 separated by a spacer coil 16, which may be superconducting or resistive.

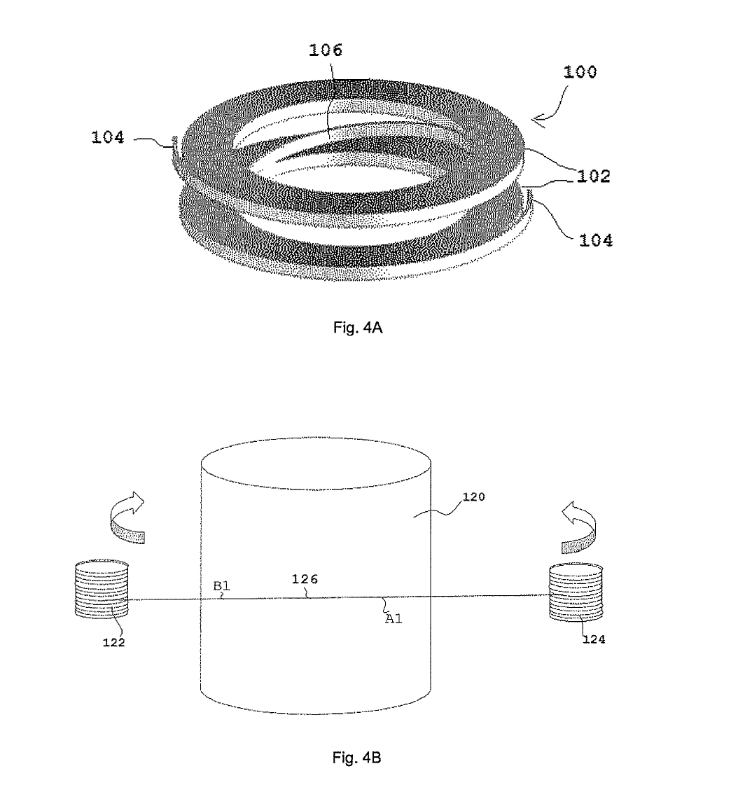

In some cylindrical superconducting magnets, and as schematically illustrated in part-cross-section in FIG. 5, a central region 24 of coils may be provided as described above, and end-coils 22 may be formed separately and attached to axial extremities of a structure 24 as described above. Typically such end-coils 22 will have a greater radial extent a—that is, a greater difference between inner and outer radii—than the coils of the associated structure 24. Spacers 26, for example in the form of conventional non-electrically conductive blocks, may be provided to locate the end coils 22 in the correct position with respect to the structure 24. Alternatively, spacer coils may be provided at axial extremities of the structure for use as such spacers 26.

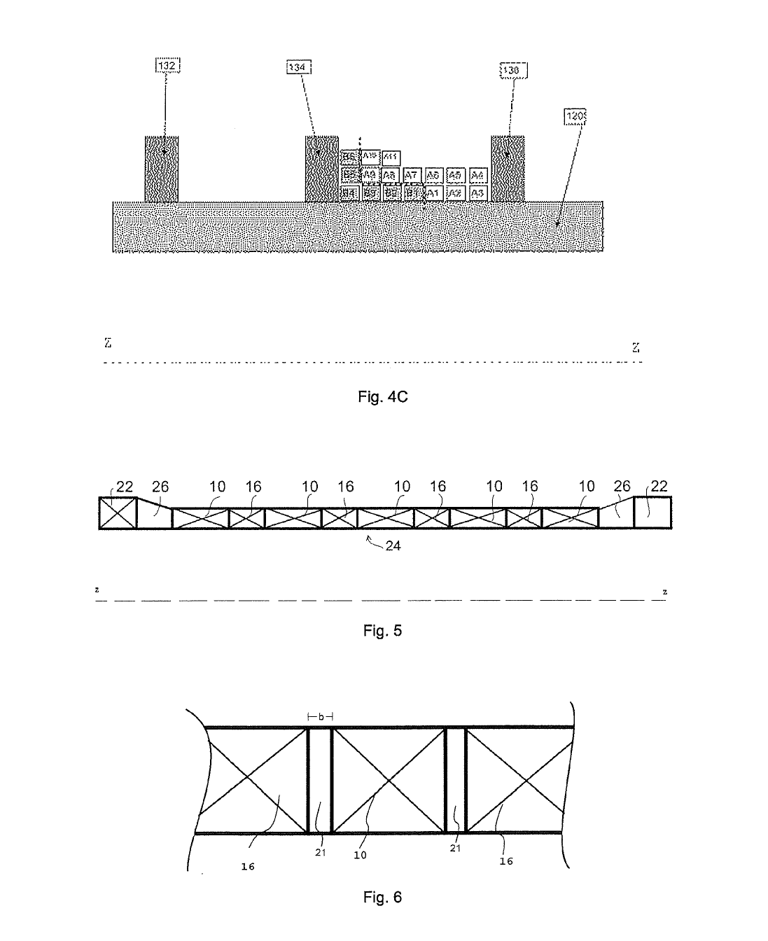

In certain embodiments, as illustrated in FIG. 6, insulating spacers 21 of axial extent b less than that of the spacer coil 16 may be provided between a spacer coil 16 and the adjoining main coil(s) 10. Such spacers are preferably annular, extending right around the circumference of the spacer coil.

Although modifications and changes may be suggested by those skilled in the art, it is the intention of the inventor to embody within the patent warranted heron all changes and modifications as reasonably and properly come within the scope of his contribution to the art.

1. A cylindrical superconducting magnet structure comprising two cylindrical superconducting main coils axially spaced apart by an annular spacer coil, said main coils and said spacer coil being directly bonded together in a single self-supporting structure by a resin, wherein the spacer coil is formed of resistive wire, and is present at a radial position corresponding to a radial mid-point of each main coil.

2. A cylindrical superconducting magnet structure according to claim 1 comprising a quench propagation circuit, wherein the spacer coil is electrically connected to the quench propagation circuit.

3. A cylindrical superconducting magnet structure according to claim 1, wherein the spacer coil is electrically connected as a closed loop.

4. A cylindrical superconducting magnet structure comprising two cylindrical superconducting main coils axially spaced apart by an annular spacer coil, said main coils and said spacer coil being directly bonded together in a single self-supporting structure by a resin, wherein the spacer coil is formed of superconducting wire, and the spacer coil and the main coils are electrically connected such that the spacer coil carries a current in an opposite direction from current carried by the main coils.

5. A cylindrical superconducting magnet structure comprising two cylindrical superconducting main coils axially spaced apart by an annular spacer coil, said main coils and said spacer coil being directly bonded together in a single self-supporting structure by a resin, wherein ends of the spacer coil are electrically unconnected.

6. A cylindrical superconducting magnet structure comprising two cylindrical superconducting main coils axially spaced apart by an annular spacer coil, said main coils and said spacer coil being directly bonded together in a single self-supporting structure by a resin, wherein the spacer coil is formed of superconducting wire, and is constructed to carry a same current as a current carried by the main coils, but at a lower current density than a current density carried by the main coils.

7. A cylindrical superconducting magnet structure according to claim 6, wherein the spacer coil is formed of superconducting wire, and the spacer coil and the main coils are electrically connected such that the spacer coil carries a current in an opposite direction from current carried by the main coils.

8. A cylindrical superconducting magnet structure according to claim 6 wherein the spacer coil is electrically connected in series with the main coils.

9. A cylindrical superconducting magnet structure according to claim 1 wherein the spacer coil has an inner radius substantially equal to the inner radius of at least one of the main coils.

10. A cylindrical superconducting magnet structure according to claim 1 wherein the spacer coil has an outer radius substantially equal to the outer radius of at least one of the main coils.

11. A cylindrical superconducting magnet structure according to claim 1 wherein the main coils and the spacer coil are monolithically bonded together in a single resin impregnation step.

12. (canceled)

13. A cylindrical superconducting magnet structure according to claim 1 wherein the spacer coil and the main coils are of a same type of wire.

14. A cylindrical superconducting magnet structure according to claim 1 wherein the spacer coil and the main coils have a same turns density.

15. A magnet structure comprising:
a cylindrical superconducting magnet structure according to any preceding claim; and
annular end-coils formed separately and attached to axial extremities of the cylindrical superconducting magnet structure.

16. A magnet structure according to claim 15, wherein the end-coils have a greater radial extent a than the coils of the cylindrical superconducting magnet structure.

17. A magnet structure according to claim 16 wherein non-electrically conductive spacers are provided to locate the end coils in the correct position with respect to the cylindrical superconducting magnet structure.

18. A magnet structure according to claim 15 wherein spacer coils are provided at axial extremities of the cylindrical superconducting magnet structure to locate the end coils in the correct position with respect to the cylindrical superconducting magnet structure.
